(19) United States
(12) Patent Application Publication
(10) Pub. No.: US 2010/0066697 A1
(43) Pub. Date: Mar. 18, 2010

(54) PRESSURE MEASUREMENT DEVICE AND CORRESPONDING METHOD

(75) Inventors: Marcel Jacomet, Lengnau (CH); Lorenz Müller, Biel-Bienne (CH); Josef Goette, Lengnau (CH); Roger Cattin, Aegerten (CH); Andreas Eicher, Langnau (CH); Alain Rollier, Ipsach (CH)

Correspondence Address: OBLON, SPIVAK, MCCLELLAND MAIER & NEUSTADT, L.L.P., 1940 DUKE STREET, ALEXANDRIA, VA, 22314, US

(73) Assignee: AXSionics AG, Biel (CH)

(21) Appl. No.: 12/559,282

(22) Filed: Sep. 14, 2009

Related U.S. Application Data
(63) Continuation of application No. PCT/EP08/00334, filed on Jan. 17, 2008.

(30) Foreign Application Priority Data
Mar. 14, 2007 (EP) 07005268.3

(51) Int. Cl. G06F 3/041

(52) U.S. Cl. 345/173

(57) ABSTRACT

A pressure measurement device and a pressure measurement method are provided, the pressure to be measured being exerted by an object onto a contact area of the pressure measurement device. The pressure measurement device comprises an image acquisition module having the contact area, image data of an elastically structured subsurface of the object being recorded. The pressure is determined and output according to the color and/or brightness values of selectively recorded image data. In particular, the invention relates to methods and devices for coordinate acquisition, navigation input, authentication of a user and for command and text input, embodied on a basis of the pressure measurement device according to the invention.

### CROSS REFERENCE TO RELATED APPLICATIONS

The present patent application claims priority to the Patent Cooperation Treaty Application with the Serial No. PCT/EP2008/000334, that was filed on Jan. 17, 2008, which itself claims priority to the European Patent Application with the Serial No. EP 07005268.3 that was filed on Mar. 14, 2007, all the contents thereof being herewith incorporated by reference.

### BACKGROUND OF THE INVENTION

(a) Field of the Invention

The present invention relates to a device and a method for measuring pressure, the pressure to be measured being exerted by an object onto a contact area of the pressure measurement device. In particular, the invention relates to methods and devices for coordinate acquisition, navigation input, authentication of a user and command and text input, embodied on the basis of the pressure measurement device.

(b) Brief Description of the Related Art

A very wide variety of devices for measuring pressure have been known for a long time in the prior art. With these devices, for example in order to measure the force exerted by an object, determination may be carried out by recording very small modifications of an elastic contact area. The deflection of the elastic contact area is then a measure of the force or the pressure. The exerted force may also be transmitted to a piezo element and converted into electrical energy by using the piezo element. The electrical energy is then likewise correlated with the level of force exerted. In other known methods in the prior art, an entire inelastic contact area's deflection generated by the force is measured. Known devices of this type are for example the spring balance, the spring displaying the exerted force according to Hooke's law.

In some background art devices, an imaging sensor is employed to store image data of a fingerprint, for example S. K. Ganapathi, “Fingerprint Authentication: Shifting the Electronic Security Paradigm”, SC On-line SC Magazine, www.scmagazine.com, XP-002481772, February 2002. A measuring instrument having a pressure sensor for recording a pressure of a finger on the sensor is furthermore described. Other types of this pressure measurement device are also described in background references, which use for example the weight force of the object or a reference object. For example the beam balance or the inclination balance are devices which fall within this category of pressure measurement devices. One of the disadvantages of the prior art devices is that the planar moment of inertia and elastic modulus of the material comprising the contact area is usually suitable for measurement only in the range of linear elastic deformations (“Hookean range”). If, for example with a spring balance, the Hookean range of the spring is departed from or exceeded by the exerted force, this not only entails the problem that the pressure can no longer be measured correctly by the spring, but the risk also arises that the spring element itself will be deformed so that it becomes unusable for further pressure measurements and must be replaced. Piezo elements, on the other hand, have the disadvantage that they are highly susceptible to influence by external interference. Piezo elements are furthermore subject to certain manufacturing tolerances, which cannot easily be corrected by calibration.

European Patent Application EP 0,919,947 presents a touch-sensitive contact area of a fingerprint sensor. The contact area comprises variable capacitors, which are formed by various mutually insulated material layers. If for example a pressure is exerted onto the contact area by a finger, then the surface deforms according to the ridges and grooves of the skin surface. This deformation of the contact area causes a change in the electrostatic capacitances and can be made available, and evaluated, as an electrical signal by using detection electronics. As another example, U.S. Pat. No. 4,394,773 presents a fingerprint sensor with a contact area or sensor plate, which is based on a piezoelectric material. If pressure is exerted onto the contact area by a finger, then electrical signals are generated by using the piezoelectric material as a function of the pressure, and these can be evaluated accordingly by using an electronic instrument. Although, for example, the two aforementioned systems and methods make it possible to record pressure variations, both EP 0,919,947 and U.S. Pat. No. 4,394,773 nevertheless have the disadvantage that the surface of the sensors must be touch-sensitive. The electronic circuits lying below the surface will therefore necessarily be mechanically stressed, which leads for example to wear phenomena and pronounced ageing.

Various devices for coordinate acquisition are furthermore known in the prior art. These devices make it possible to record planar coordinates, for example in an x and y plane, or even to input further dimensions using device add-ons. For example, the movement of a computer mouse on a surface may be determined by a spoked wheel moving past a photoelectric barrier for each direction and by converting the light pulses correspondingly into x/y coordinates. One of the disadvantages of computer mice is that they are only suitable for coordinate acquisition on a flat plane. In other known methods in the prior art, for example with a trackpad, an object is moving over a touch-sensitive or at least elastic surface so that coordinates on the two-dimensional plane can be recorded along the contact line. This may, for example, be achieved by capacitively sensitive surfaces. Furthermore, trackpads are known in which a force exerted onto the contact area of the trackpad is also recorded in addition to the planar coordinates. The exerted force is determined by using the elasticity of the contact surface. One of the disadvantages of such devices is that the contact area must be made elastic or mobile, which again leads to the disadvantages mentioned above. U.S. Pat. No. 7,162,059 presents such an example for the input of coordinates in x and y directions by using a fingerprint sensor. The method presented in U.S. Pat. No. 7,162,059, however, does not allow for example further coordinate input, for example by using recording pressure. Thus, for example, computer instructions by using a “click” (selection process) executed by pressure are therefore not possible.

Various systems for authenticating a user by using a fingerprint are also known in the prior art. For example, U.S. Pat. No. 7,190,816 presents a method of authentication by using a fingerprint. The fingerprint is recorded as image data by a small fingerprint sensor. Image data of a second fingerprint of the user are also recorded by using the fingerprint sensor. In order to authenticate the user, the image data of the first fingerprint are compared for a match with the image data of the second fingerprint. One disadvantage of such a method is, for example, that authentication with copies of fingerprints, for example by using a finger formed by wax or gelatine, can readily be achieved by other users in a fraudulent or abusive way. Security of the authentication is not therefore guaranteed in all cases. Automatic authentication by using fingerprint sensors is an integral part in many security systems. For instance, fingerprint sensors are installed in laptops, mobile telephones, portable security tokens or computer mice, the user gaining access to particular applications by being authenticated by using a fingerprint. Particularly in the case of security tokens designed for miniaturisation, external effects may lead to the process of authenticating the appropriate person being unsuccessful, or at least made more difficult. Such impeding effects may for example be dirt or sweat, which interfere with the data determination when a part of the body touches the sensor. Temperature changes or injuries, for example of a finger, can also sometimes have a detrimental effect on an authentication process. These effects can be compensated for during authentication by corresponding measures, so-called “exception handling”. One of these measures consists particularly in also recording nonbiometric parameters in addition to the characteristic biometric features. Such a parameter is for example the force applied by a user by using a finger onto a trackpad or a fingerprint sensor, or the corresponding pressure. Another such possibility is for a password or a personal identification number (PIN) also to be input by the user for authentication by using a keypad. This, however, requires additional interaction by the user. There is furthermore the risk that the password will be forgotten by the user or fall into the wrong hands.

Various methods for text input are furthermore described in the background art, in which for example a simplified input device, for example an input wheel or a limited number of keys, are used instead of a full keyboard. For example, particular symbols can in this case be selected by the input device from a multiplicity of symbols that can be represented on a display module. A cursor element is then positioned on the display module by moving the input wheel. The symbol is selected on the basis of the position of the cursor element by pressing the wheel or a key, for example U.S. Pat. No. 6,011,542. One of the disadvantages of this method is that the input wheel responds sensitively to external effects, for example dirt, which accelerates the ageing process of the input device and makes the input device susceptible to operational interference.

### SUMMARY OF THE INVENTION

It is therefore an object of the present invention to provide a new pressure measurement device and a corresponding pressure measurement method, which does not have the disadvantages mentioned. The pressure measurement device is intended to measure and output the pressure exerted by using an object onto a contact area. In particular, the pressure measurement device should be mechanically simple to produce and maintain. It should furthermore be robust against environmental effects and guarantee high operational reliability. Furthermore, on the basis of the described pressure measurement device, an authentication device based on biometric features is to be provided which does not comprise the disadvantages mentioned above and has a high security standard. A method and a device for navigation input, command input or text input on the basis of the described pressure measurement device are likewise to be provided.

According to the present invention, these objects are achieved in particular by the elements of the independent claims. Other advantageous embodiments may furthermore be found in the dependent claims and the description.

In particular, these objects are achieved by the invention in that a force exerted by a subsurface of an object onto a contact area of a pressure measurement device is measured by using the pressure measurement device and a corresponding pressure value parameter is generated, in that a pressure measurement device comprises an image acquisition module, comprising the contact area, for recording and storing image data of an elastically structured subsurface of the object, pixels of the subsurface being recordable as correspondingly graduated color and/or brightness values of the image data according to their distance from the contact area, in that the pressure measurement device comprises an integration module having a stack memory which can be incremented according to the color and/or brightness values of the image data, the stack memory comprising a readable stack memory level value, in that the pressure measurement device comprises a filter module for generating the pressure value parameters, a pressure value parameter being allocatable by using the filter module to the stack memory level value read out. One of the advantages of the invention is that the contact area can be made immobile, stiff and/or rigid. Since the deformation of such a surface is superfluous to the pressure measurement, it is resistant against material fatigue and correspondingly wearproof. A further advantage of the invention is in particular that the pressure measurement can even be measured in the nonlinear range. For example, a pressure measurement can succeed even with extremely minor contact of the elastically structured surface of the object with the contact area of the image acquisition module. Another advantage of this device is that a pressure measurement is for example possible even under water or in a vacuum. A further advantage of the invention is that the pressure measurement can in principle be carried out with the aid of the same image data as are used to obtain biometric features, for example for authentication. Furthermore, additional components such as piezo elements can be obviated. Besides the pressure value parameter, the pressure measurement device may also generate x/y coordinate data directly by using the image acquisition module and transmit them to further modules.

In an alternative embodiment, these objects are achieved by the invention in that the filter module of the pressure measurement device comprises a lookup table, value pairs which respectively comprise a reference value and a correspondingly allocated pressure value parameter being stored in the lookup table, and in that the filter module comprises a comparison module for comparing a stack memory level value transmitted to the comparison module with the reference values of the lookup table, the corresponding pressure value parameter being allocatable on the basis of the comparison in order to generate the pressure value parameter by using the lookup table. One of the advantages of the invention is that the pressure value parameter can be made available by the lookup table in an extremely short time and read out immediately, since the pressure value parameter does not have to be determined or calculated again before each readout process. Because elaborate calculations are obviated, convenient and resource-saving memory components can be used.

In an alternative embodiment, these objects are achieved by the invention in that the filter module of the pressure measurement device comprises a correlation module for allocating a stack memory level value, transmitted to the correlation module, to a pressure value on the basis of at least one exponentiation and/or at least one multiplication and/or at least one addition factor, the corresponding pressure value parameter being generatable on the basis of the correlation. One of the advantages of the invention is that a pressure value parameter can be calculated exactly on the basis of a stack memory level value according to the correlation factors, the factors being modifiable and adaptable if need be. A further advantage of the invention is that the parameters for such a “fit function” can be adapted according to an object's specific, elastically structured subsurface touching the contact area, so that individualised tuning of the pressure measurement is possible.

In an alternative embodiment, these objects are achieved by the invention in that the pressure measurement device comprises an interface module for generating control signals and/or data signals on the basis of the pressure value parameter. One of the advantages of the invention is that control signals of the pressure measurement device can be transmitted to other devices. These control signals are used, for example, to initiate an event. A further advantage of the invention is that data signals can for example be used to transmit the pressure value to an output unit of the pressure measurement device, such as a display unit, in which case a pressure value may for example be output in the units N/m², pascals, bars or atmospheres. A further advantage of the invention is that the interface module may also be configured as a bus or line system for interchanging data and/or control signals between potentially more than two subscribers or modules. The output unit may also be produced as an acoustic unit, for instance as a loudspeaker module.

In an alternative embodiment, these objects are achieved by the invention in that the image acquisition module comprises a scan module having an optically transparent contact area, pixels of the subsurface being recordable as correspondingly graduated color and/or brightness values of the image data according to their distance from the contact area. One of the advantages of the invention is that for the pressure determination, the pressure measurement device can measure pressure by simple technical means, for example based on optical and/or capacitive recording and/or by using a “radiofrequency” sensor technology, the image acquisition module being for example a fingerprint sensor. In the case of RF sensor technology, for example, a radiofrequency signal is emitted by a sensor and corresponding signal reflections are measured. By using the radiofrequency signal, it is therefore possible to record ridges and grooves of the skin surface touching the contact area. Such fingerprint sensors represent a further possibility in addition to optical or capacitive technologies. In principle, an object is accordingly scanned i.e. sampled or analysed in a systematic, regular way. Therefore, for example on the basis of the same image data of a fingerprint or a partial fingerprint, pressure value parameters can be recorded simultaneously with biometric characteristics.

In an alternative embodiment, these objects are achieved by the invention in that the force exertable by using an elastically structured subsurface onto the contact area of a pressure measurement device is recorded by using a calibrated second measurement device, in that image data of the elastically structured subsurface of the object are recorded as correspondingly graduated color and/or brightness values according to their distance from the contact area by using an image acquisition module of the pressure measurement device, in that a stack memory of an integration module of the pressure measurement device is incremented on the basis of the color and/or brightness values of the image data, a corresponding pressure value parameter being generated by using a filter module on the basis of the stack memory level value, and the stack memory level value and the pressure value parameter allocated to it are transmitted as a value pair into the lookup table and/or transmitted as a calibration value pair into the correlation module of the pressure measurement device. This has the advantage inter alia that the pressure value parameters determined by using the calibrated second pressure measurement device correspond to absolute pressure values. These may either be stored as calibration value pairs in a lookup table or defined by using a correspondingly tuned correlation function. Calibration of the pressure measurement parameters may also be carried out individually or per user.

In particular, these objects are also achieved by the invention in that a coordinate acquisition device comprises a touch-sensitive contact area for recording planar x/y coordinate data of a subsurface, touching the contact area, of an object, and a coordinate acquisition module for generating corresponding signal data, in that the contact area is a component of a pressure measurement device, a corresponding pressure value parameter being generatable by using the pressure measurement device when an elastically structured subsurface of an object touches the contact area, in that the coordinate acquisition device comprises a filter module for generating z coordinate data as a function of the pressure value parameter, corresponding z coordinate data being allocatable to each possible pressure value parameter by using the filter module, and in that the coordinate acquisition device comprises a coordinate acquisition module for generating corresponding signal data as 3D coordinate data on the basis of the z coordinate data and the x/y coordinate data recorded by using an image acquisition module of the pressure measurement device. This has the advantage inter alia that, in contrast to the prior art, coordinate data of a three-dimensional space or 3D coordinate data can also be generated without the contact area touched by a subsurface of the object needing to have elastic properties. Movements of the object on the contact area in the x and y directions are in this case determined definitively by the physical dimensions of the contact area. In the z direction, i.e. mainly at right angles to the contact area, the size of the z coordinate is determined in particular by the elasticity of the structured object surface, the distance of the structures from the surface being recordable as pixels and the pixels being capable of having corresponding color and/or brightness values according to their distance from the contact area.

In another alternative embodiment, these objects are achieved by the invention in that the coordinate acquisition device comprises an interface module for generating control signals and/or data signals on the basis of the 3D coordinate data. Such an alternative embodiment has the advantage that the 3D coordinate data can correspondingly be transmitted as control signals and/or data signals to other modules by using the interface module. The interface module may inter alia be configured as a bus and/or parallel and/or serial interface.

In another alternative embodiment, these objects are achieved by the invention in that the filter module of the coordinate acquisition device comprises a lookup table, value pairs which respectively comprise a reference value and a correspondingly allocated pressure value parameter being storable in the lookup table, and in that the filter module comprises a comparison module for comparing a stack memory level value transmitted to the comparison module with the reference values of the lookup table, the corresponding z coordinate data being allocatable on the basis of the comparison in order to generate the z coordinate data by using the lookup table. This has the advantage inter alia that the assignment of corresponding z coordinate data to a pressure value parameter can be carried out rapidly by using the lookup table.

In another alternative embodiment, these objects are achieved in that the filter module of the coordinate acquisition device comprises a correlation module for allocating a stack memory level value, the stack memory level value transmitted to the correlation module, to the corresponding z coordinate data on the basis of at least one exponentiation and/or at least one multiplication and/or at least one addition factor, to thereby generate the corresponding z coordinate data. Such an alternative embodiment has the advantage that an exact correlation between the corresponding z coordinate data and a pressure value parameter is possible by using the correlation module. The correlation module may be embodied in hardware and/or software.

In particular, the objects are also achieved by the invention in that planar x/y coordinate data of a subsurface, touching the contact area, of an object are recorded by using a touch-sensitive contact area of a navigation input device, and a coordinate acquisition module as well as a timer module generate corresponding time-dependent signal data, in that the pressure measurement device comprises a timer and/or scheduler module for generating at least one timebase and/or corresponding time value parameters, in that planar x/y coordinate data can be recorded by using the image acquisition module of the pressure measurement device, and in that the navigation input device comprises an adder module for adding 3D coordinate data and time value parameters and for generating corresponding time-dependent 3D coordinate data. This has the advantage inter alia that navigation with the aid of four dimensions x, y, z and t is possible by using the navigation input device. For example, the sequence of 3D coordinate data within a particular time may be followed by using the navigation input device.

In another alternative embodiment, the navigation input device comprises an interface module for generating control signals and/or data signals on the basis of the time-dependent 3D coordinate data. Such an alternative embodiment has the advantage that the time-dependent 3D coordinate data may be transmitted inter alia via a bus and/or a line system to a display module, or that the data may be transmitted for further processing to a processor system or into a memory.

In particular, the objects are also achieved by the invention in that a user can be authenticated by using an authentication device, identified stored image data as reference image data of a fingerprint or a subregion thereof being comparable with image data, to be identified, of a further fingerprint or a subregion thereof, a corresponding authentication parameter being generatable as a function of the comparison, in that the pressure value parameter recorded by using a pressure measurement device can be correspondingly allocated to the image data of the first image to be identified, in that the pressure value parameter recorded by using a pressure measurement device can be correspondingly allocated to the image data of the further image, and in that the authentication device comprises a filter module for generating the authentication parameter on the basis of the match of the corresponding pressure value parameters and as a function of the match of the identified image data with the image data of the further image. This has inter alia the advantage that when identifying by using image data of a fingerprint, it is additionally possible to check whether the object touching the contact area corresponds to a fingerprint of a person or whether a copy of a fingerprint has merely been applied onto the contact area. In the latter case the copy, for example on a piece of paper or a film, has the corresponding elasticity properties so that the structure does not change substantially as a function of the force exerted onto the contact area. The pressure value parameter would change only insubstantially or not at all during an authentication process. This device therefore leads to increased authentication security.

In another alternative embodiment, these objects are achieved by the invention in that a filter module of the authentication device comprises a lookup table, value pairs which respectively comprise a reference value and a correspondingly allocated pressure value parameter being stored in the lookup table, and in that the filter module comprises a comparison module for comparing a stack memory level value transmitted to the comparison module with the reference values of the lookup table, the corresponding authentication parameter being allocatable on the basis of the comparison in order to generate the authentication parameter by using the lookup table. Such an alternative embodiment has the advantage that very rapid assignment of a corresponding pressure value parameter to a reference value takes place.

In particular, the objects are also achieved by the invention in that a user can be authenticated by using an authentication device, identified time-dependent x/y coordinate data of a subsurface, touching a touch-sensitive contact area, of an object, which are stored as signature data, being comparable with x/y coordinate data to be identified, and means for generating corresponding authentication parameters, in that the contact area is a component of a navigation input device, corresponding time-dependent 3D coordinate data being generatable by using the navigation input device when an elastically structured subsurface of the object touches the contact area, in that the authentication device comprises means for storing time-dependent 3D coordinate data as signature data, and in that the authentication device comprises a filter module for generating the authentication parameter on the basis of the comparison of the signature data with the recorded 3D coordinate data. This has the advantage inter alia that authentication of a user is achieved by a previously stored and identified signature being replicated, for example by using a finger on a fingerprint sensor. A signature may be an autograph, a geometrical figure and the like. A signature is characterised in that x, y, z coordinate data along the path of the signature are recorded and stored. In addition, a time value parameter may be allocated to the 3D coordinate data. The finger can be moved over the narrow fingerprint sensor while recording the signature, so that only slight movements are necessary.

In another alternative embodiment, these objects are achieved by the invention in that user-specific image data of a fingerprint and/or a subsurface of an object are allocated to a multiplicity of the recorded coordinate data by using the signature authentication method, and in that the recorded image data are compared with the identified reference image data, corresponding authentication parameters being generated if the comparison matches. Such an alternative embodiment has the advantage that image data recorded by using the image acquisition module can also be used for authentication by using a fingerprint, so that a combination of authentication by using a fingerprint and authentication by using a signature is possible.

In another alternative embodiment, these objects are achieved by the invention in that the authentication device comprises an interface module for generating control signals and/or data signals on the basis of the at least one authentication parameter. Such an alternative embodiment has the advantage that the authentication parameters can correspondingly be transmitted as control signals and/or data signals to other modules by using the interface module. The interface module may inter alia be configured as a bus and/or parallel and/or serial interface.

In another alternative embodiment, these objects are achieved by the invention in that the authentication device comprises means for determining subregions of subsurfaces of an object, and in that the authentication device comprises means for comparing at least two subregions for a match. Such an alternative embodiment has the advantage that only small regions of a subsurface of an object, for example a finger pad, have to be recorded by using the authentication device. The authentication process can therefore be accelerated.

In particular, the objects are also achieved by the invention in that, by using a command input device, planar coordinate data stored as specified command pattern data can be compared for a match with x/y coordinate data of a subsurface, touching a touch-sensitive contact area and moved over it, of an object, and comprises means for generating corresponding command parameters, in that the contact area is a component of a pressure measurement device, in that planar coordinate data can be recorded by using an image acquisition module of the pressure measurement device, in that corresponding pressure value parameters can be recorded by using the pressure measurement device, in that the command input device comprises a filter module for allocating corresponding pressure value parameters to a multiplicity of the planar coordinate data, in that the command input device comprises a filter module for generating the command parameter on the basis of the comparison of the planar coordinate data and/or the pressure value parameters of the specified command pattern data with the recorded planar coordinate data and/or the pressure value parameters, and in that the command input device comprises an interface module for generating control signals and/or data signals on the basis of the at least one command parameter. This has the advantage inter alia that commands or instructions recorded by using the command input device can be compared with commands or instructions stored as reference data and/or reference patterns and transmitted as command parameters to a processor module by using the interface module if there is a match. This makes it possible for a user to transmit simple instructions to the corresponding device on the basis of a library of instructions.

In particular, the objects are also achieved by the invention in that at least one symbol can be selected from a multiplicity of symbols representable on a display module by using interaction with an object and an input unit, a cursor element being positioned on the display module by the interaction, the symbol being selected and a data signal being generated and transmitted on the basis of the position of the cursor element, in that the input unit is embodied as a contact area of a pressure measurement device having an image acquisition module, planar coordinate data being recorded by using the pressure measurement device, in that corresponding pressure value parameters are recorded by using the pressure measurement device, the cursor element being positioned as a function of the x/y coordinate data on the symbol to be selected, in that the chosen symbol is selected on the basis of the pressure value parameter generated by using the pressure measurement device, and in that the data signal is generated and transmitted by using a filter module of the pressure measurement device on the basis of the selected symbol. This has inter alia the advantage that, for example in the case of a security token consisting of a display module and a fingerprint sensor, a dialogue is made possible between a user and the security token. If numbers from 0 to 9, a symbol for “correction” or “clear”, a symbol for “input confirmation” or “enter” and a cursor element are represented on the display module, then the user can position the cursor element on the symbol to be selected with a finger on the image acquisition module as a function of the x/y position of his or her finger on the contact area, and can select the corresponding symbol by pressing the finger onto the contact area. This makes it possible to input for example a personal identification number (PIN).

In particular, the objects are also achieved by the invention in that at least one symbol can be selected from a multiplicity of symbols representable on a display module by using interaction with an object and an input unit, a cursor element being positioned on the display module by the interaction, the symbol being selected and a data signal being generated and transmitted on the basis of the position of the cursor element, in that the input unit is embodied as a contact area of a pressure measurement device having an image acquisition module, planar coordinate data being recorded by using the pressure measurement device, in that corresponding pressure value parameters are recorded by using the pressure measurement device, the cursor element being positioned as a function of pressure value parameter on the symbol to be selected, in that the symbol is selected on the basis of the x/y coordinate data generated by using the pressure measurement device, and in that the data signal is generated and transmitted by using a filter module of the pressure measurement device on the basis of the selected symbol. This has inter alia the advantage that a symbol and/or a number can be selected from a multiplicity of symbols and/or numbers arranged on a line so that the cursor element is positioned according to the pressure value parameter on the symbol through exertion of pressure onto the contact area by an object and is selected by moving the object in the x/y direction.

At this point, it should be mentioned that in addition to the methods, the present invention also relates to devices for carrying out corresponding methods.

### BRIEF DESCRIPTION OF THE DRAWINGS

These and other features, aspects and advantages of the present invention will become better understood with regard to the following description, appended claims and accompanying drawings where:

FIG. 1 shows a schematic representation of a pressure measurement device;

FIG. 2 shows a schematic representation of a coordinate acquisition device;

FIG. 3 shows a schematic representation of a navigation input device;

FIG. 4 shows a schematic representation of an authentication device;

FIG. 5 shows a schematic representation of a command input device;

FIG. 6 shows a schematic representation of a functional dependency of pressure value parameters with the stack memory level value;

FIG. 7a shows a schematic representation of a subset of pixels of an elastically structured subsurface, touching a contact area, of an object when the object exerts a small force onto the contact area;

FIG. 7b shows a schematic representation of a subset of pixels of an elastically structured subsurface, touching a contact area, of an object when the object exerts an increased force onto the contact area;

FIG. 8a shows a schematic representation of a display unit for the output of symbols in a matrix representation and the interaction of a user by using his or her finger on an input unit;

FIG. 8b shows a schematic representation of a display unit for the output of symbols in a wheels type representation; and

FIG. 9 shows a schematic representation of papillary line and a corresponding auxiliary analysis.

Herein, identical reference numerals are used, where possible, to designate identical elements that are common to the figures. The images in the drawings are simplified for illustrative purposes and are not depicted to scale.

### DETAILED DESCRIPTION OF THE INVENTION

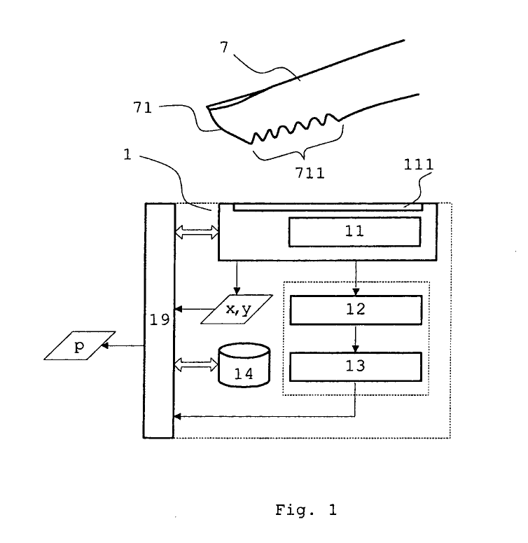

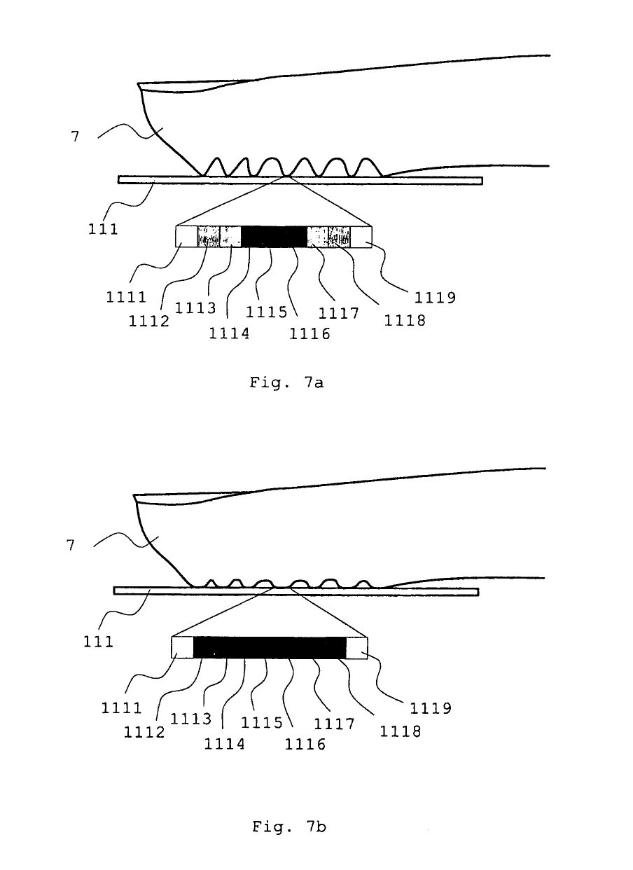

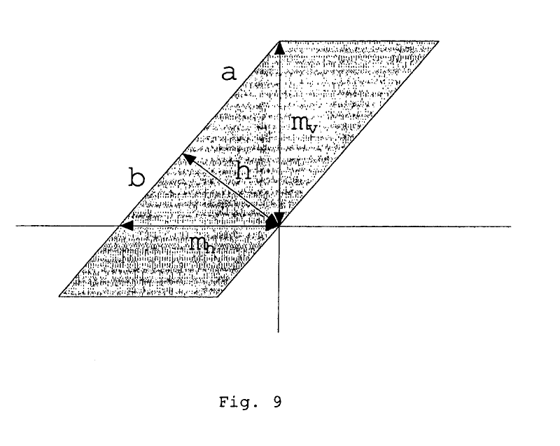

FIG. 1 illustrates a device which can be used to produce the pressure measurement device according to the invention. FIG. 1 shows a schematic representation of a device according to the invention for measuring pressure. A force is exerted by a subsurface 711 of an object 7 onto a contact area 111 of the pressure measurement device 1, and a corresponding pressure value parameter is generated. The reference 7 denotes an object, for example a finger or another human body part. This object 7 is distinguished in particular in that at least a part of the surface of the object 7 is elastically structured. The reference number 71 refers to the surface of the object 7. The reference 711 denotes a subsurface or surface region of this surface 71. The structures of the subsurface 711 may comprise patterns, arches and loops with ridges and grooves of the surface. Such structures of subregions 711, for example of a finger pad or the ball of a thumb, are used for example in dactyloscopy for the recognition of persons. By using dactyloscopy, for example, it is possible to study papillary lines on the insides of hands and the lower sides of feet. Such structures are normally at least partially elastic. One feature of elastic objects or bodies is inter alia that they change their shape under the effect of a force and return to the original shape after the acting force is removed. The elastically structured subsurface 711 is moved onto a contact area denoted by the reference 111. Such a contact area 111 may be configured rigidly. When the elastic structured subsurface 711 of the object 7 is pressed against the contact area 111, the elastic structure of the subsurface 711 deforms. The modifications of the structure are correlated with the force exerted by the subsurface 711 of the object 7 onto the contact area 111. The contact area 111 may be configured as a contact area which is optically transparent and/or transparent for sound waves. The contact area 111 is a component of an image acquisition module 11. The image acquisition module 11 comprises a scan module having an optically transparent contact area 111 and/or comprises a scan module having capacitive and/or RF sensor technology. Pixels of the subsurface 711 can be recorded as correspondingly graduated color and/or brightness values of the image data according to their distance from the contact area 111. The image acquisition module may be configured as a fingerprint sensor. Such fingerprint sensors may for example have a resolution of 16×192=3072 4-bit pixels and be configured as a narrow strip sensor. When the subsurface 711 of the object touches the contact area 111, the image acquisition module 11 records pixels which the image acquisition module 11 records and stores as differentiable color and/or brightness values. The image acquisition module 11 may record x/y coordinate data of an object touching the contact area, for example as position data in relation to the dimensions or the pixel resolution of the contact area. The reference 14 denotes a memory module, in which these image data are stored and read out again at a later time. The memory module may be configured for example as RAM, flash, hard disk or the like. The pixels denoted by the references 1111 to 1119 in FIGS. 7a and 7b, which are recorded by using the image acquisition module 11 as image data and storable in the memory module. FIG. 7a shows more brighter pixels, while FIG. 7b shows more darker pixels. It can also be seen from FIG. 7a that the object 7 is only touching the contact area 111 lightly, that is to say only a small force is exerted onto the contact area by the object. FIG. 7b shows one with increased force exerted by the object 7 onto the contact area 111. These pixels 1111 to 1119 show only a selection of possible pixels of a contact area 111. The image acquisition module 11 therefore scans an “image” of the elastically structured subsurface according to its distance from the contact area 111. The pressure measurement device 1 may for example have means for selecting subregions of this image. From images recorded sequentially by the image acquisition module 11, an identical subregion can thus be determined in each case. The pressure measurement device may also comprise means for connecting subregions of a subsurface 711 of an object. The determination of a pressure value parameter p_{wr} is in a functional relation with the recorded color and/or brightness values of the pixels. One possible way of determining a pressure value parameter may, for example, be to add up color and/or brightness values present in a subregion by using an incrementable stack memory that can be part of an integration module 12. Another way of determining a pressure value parameter may, for example, be to determine the width of a papillary line (“widening ridge”) by using a geometrical calculation which follows the calculation below on the basis of the schematic representation of a papillary line in FIG. 9 (h corresponds to the width of a papillary line, mᵥ corresponds to the height of a papillary line in the vertical direction, mₕ to the width of a papillary line in a horizontal direction, a and b are auxiliary variables):

p_{wr}\hat{=}h² h²=a·b,

mₕ²=b·(a+b),

mᵥ²=a·(a+b),

mₕ²+mᵥ²=(a+b)². Formula 1: Calculation of a pressure value indicator (“widening ridge” method).

A pressure value parameter may for example also be determined with the aid of frequencies of color and/or brightness values of the pixels of a subregion of a subsurface 711. In the background art, fingerprint sensors are for example known which make the aforementioned brightnesses available as a so-called pixel histogram. In order to determine a pressure value parameter, frequencies of darker pixels are to be compared with frequencies of brighter pixels. A threshold value may be employed for determining the pressure value parameter, so that for example a contact signal can be generated. In this case, Pₚₕ corresponds to a resulting pressure value indicator, th to a threshold value and k to a number variable for forming a sum. In general, the calculation may also be represented as dividing the sum of all color and/or brightness values of “darker” pixels by the sum of the color and/or brightness values of the “brighter” pixels, the pixels having been determined for example by using a fingerprint sensor:

$${p}_{ph} \hat{=} \frac{{\sum }_{k = th + 1}^{16} bin ( k )}{{\sum }_{k = 1}^{th} bin ( k )} = \frac{“ dark pixels ”}{“ bright pixels ”} \\ \begin{matrix}Calculation of a pressure value \\ indicator ( {}^{``} pixel {histogram}^{″} method ) .\end{matrix} \qquad Formula 2$$

The determination of the pressure value parameter may be carried out in software and/or in hardware. The filter module denoted by the reference 13 may comprise a lookup table, value pairs which respectively comprise a reference value and a correspondingly allocated pressure value parameter being stored in the lookup table. The filter module 13 may comprise a comparison module for comparing a stack memory level value transmitted to the comparison module with the reference values of the lookup table, the corresponding pressure value parameter being allocatable on the basis of the comparison in order to generate the pressure value parameter by using the lookup table. The filter module 13 may also comprise a correlation module for allocating a stack memory level value, transmitted to the correlation module, to a pressure value on the basis of at least one exponentiation and/or at least one multiplication and/or at least one addition factor, the corresponding pressure value parameter being generatable on the basis of the correlation. This correlation module may for example be implemented as a “fit function” in hardware and/or software. The pressure measurement device 1 may comprise a processor, which can calculate and carry out in particular the recording and storage of image data, and the calculation of the pressure value parameter and filter functions. The memory module 14 may be an integrated component of a processor or microprocessor. The pressure measurement device may comprise an interface module 19 for generating control signals and/or data signals on the basis of the pressure value parameter. In this case, the pressure value parameter may for example be transmitted to a display module, an acoustic output unit or an alarm signal generation unit.

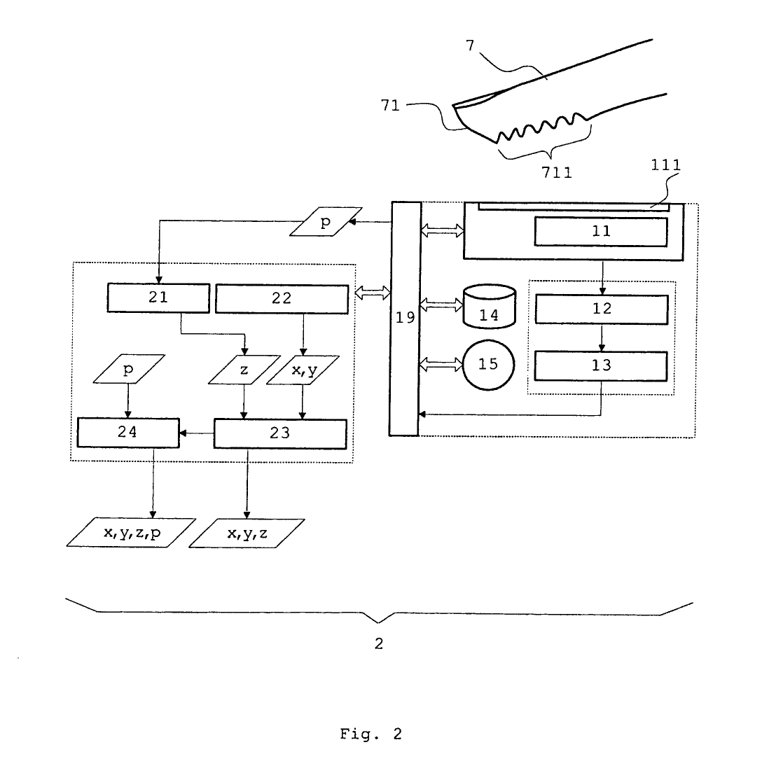

In FIG. 2, the coordinate acquisition device according to the invention is denoted by the reference 2. The coordinate acquisition device comprises a touch-sensitive contact area 111 for recording planar x/y coordinate data of a subsurface, touching the contact area, of an object 7. It also comprises a coordinate acquisition module 22 for generating corresponding signal data. The x/y coordinate data are recorded by the image acquisition module 11 and transmitted to the coordinate acquisition module 22. The contact area 111 is a component of a pressure measurement device 1. When the contact area 111 is touched by an elastically structured subsurface 711 of an object 7, a corresponding pressure value parameter can be generated by the pressure measurement device 1. The coordinate acquisition device 2 comprises a filter module 21 for generating z coordinate data as a function of the pressure value parameter, corresponding z coordinate data being allocatable to each possible pressure value parameter by using the filter module 24. The coordinate acquisition device 2 comprises a coordinate acquisition module 23 for generating corresponding signal data as 3D coordinate data on the basis of the z coordinate data and the x/y coordinate data recorded by using an image acquisition module 11 of the pressure measurement device 1.

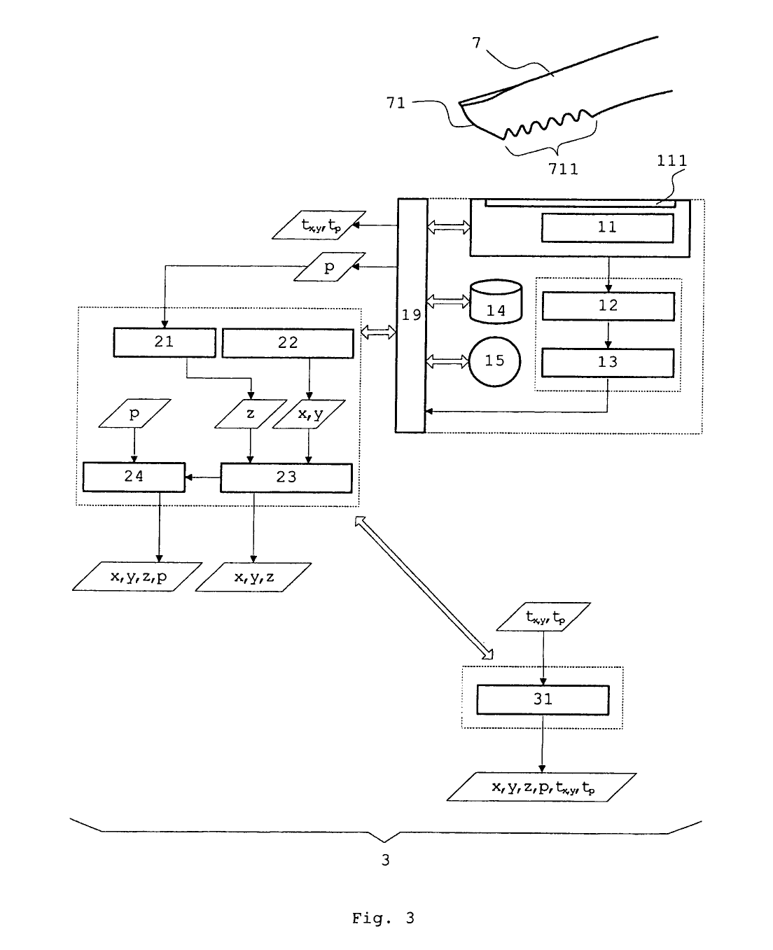

In FIG. 3, the reference 3 denotes the navigation input device according to the invention. The navigation input device comprises a touch-sensitive contact area 111 for recording planar x/y coordinate data of a subsurface, touching the contact area, of an object 7, and a coordinate acquisition module 22 as well as a timer module for generating corresponding time-dependent signal data. The pressure measurement device 1 comprises a timer and/or scheduler module 15 for generating at least one timebase and/or corresponding time value parameters. Planar x/y coordinate data can be recorded by using the image acquisition module 11 of the pressure measurement device 1. The navigation input device 3 comprises an adder module 31 for adding 3D coordinate data and time value parameters and for generating corresponding time-dependent 3D coordinate data. The navigation input device 3 comprises an interface module 19 for generating control signals and/or data signals on the basis of the time-dependent 3D coordinate data, so that x, y, z coordinate data and pressure value parameters p and time value parameters t_{x,y} and tₚ are available.

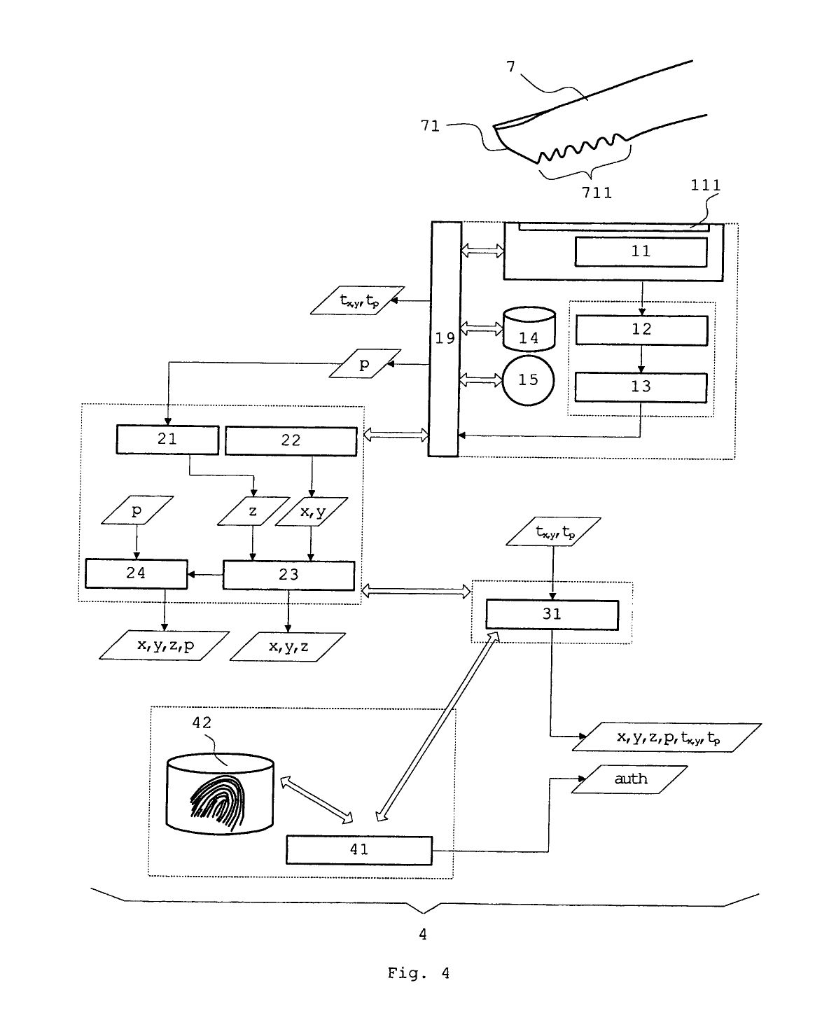

In FIG. 4, the reference 4 denotes the authentication device 4 according to the invention for authenticating a user. The identified stored image data 42 of a fingerprint can be compared with image data, to be identified, of a further fingerprint, a corresponding authentication parameter being generatable as a function of the comparison. The pressure value parameter recorded by using the pressure measurement device 1 can be correspondingly allocated to the image data of the first image to be identified. The pressure value parameter recorded by using a pressure measurement device 1 can be correspondingly allocated to the image data of the further image. The authentication device 4 comprises a filter module 41 for generating the authentication parameter on the basis of the match of the corresponding pressure value parameters and as a function of the match of the identified image data with the image data of the further image.

Identified time-dependent x/y coordinate data of a subsurface, touching a touch-sensitive contact area 111, of an object 7, which are stored as signature data, can also be compared with x/y coordinate data to be identified, and the authentication device comprises means for generating corresponding authentication parameters. The contact area 111 is a component of a navigation input device 3, corresponding time-dependent 3D coordinate data being generatable by using the navigation input device 3 when an elastically structured subsurface 711 of the object 7 touches the contact area 111. The authentication device 4 comprises means 42 for storing time-dependent 3D coordinate data as signature data. The authentication device 4 comprises a filter module 41 for generating the authentication parameter on the basis of the comparison of the signature data with the recorded 3D coordinate data. The filter module 41 of the authentication device 4 comprises a lookup table, value pairs which respectively comprise a reference value and a correspondingly allocated pressure value parameter being stored in the lookup table. The filter module 41 comprises a comparison module for comparing a stack memory level value transmitted to the comparison module with the reference values of the lookup table, the corresponding authentication parameter being allocatable on the basis of the comparison in order to generate the authentication parameter by using the lookup table. The authentication device 4 comprises an interface module 19 for generating control signals and/or data signals on the basis of the at least one authentication parameter. The authentication device 4 comprises means for determining subregions 7111 of subsurfaces 711 of an object 7. The authentication device 4 comprises means for comparing at least two subregions 7111 for a match.

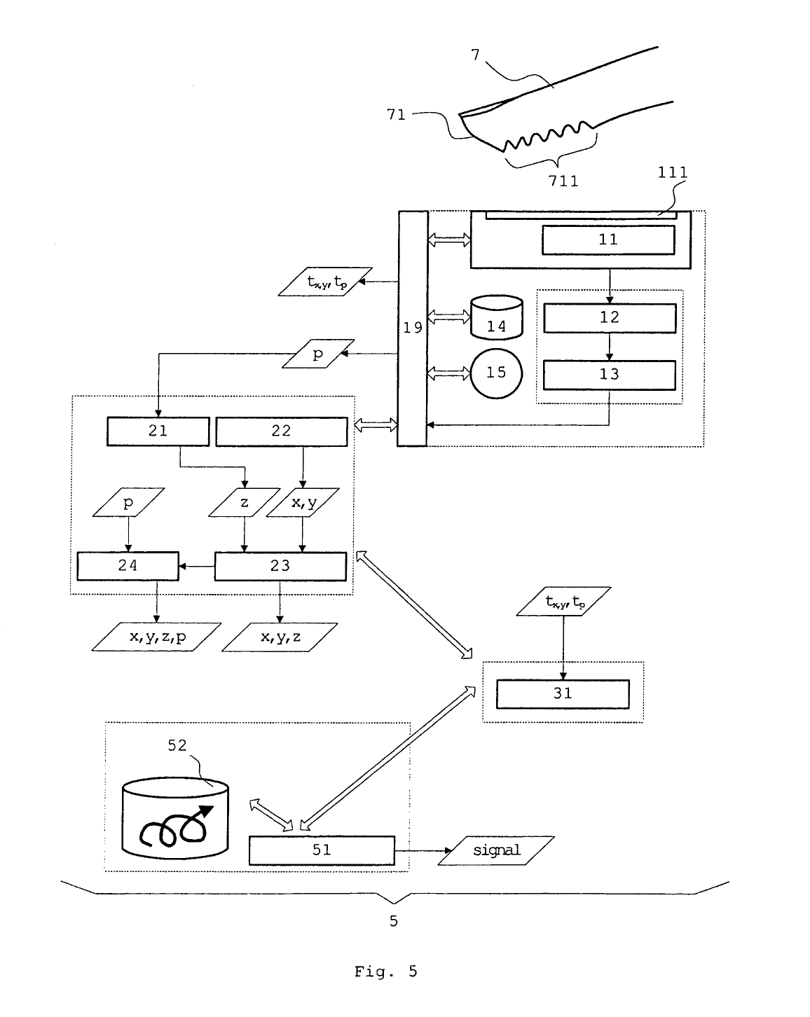

In FIG. 5, the reference 5 denotes the command input device according to the invention, planar coordinate data stored as specified command pattern data being comparable for a match with x/y coordinate data of a subsurface, touching a touch-sensitive contact area 111, of an object 7. The command input device 5 comprises means for generating corresponding command parameters. The contact area 111 is a component of a pressure measurement device 1. Planar coordinate data can be recorded by using an image acquisition module 11 of the pressure measurement device 1. Corresponding pressure value parameters can be recorded by using the pressure measurement device 1. The command input device 5 comprises a filter module for allocating corresponding pressure value parameters to a multiplicity of the planar coordinate data. The command input device 5 comprises a filter module 51 for generating the command parameter on the basis of the comparison of the planar coordinate data and/or the pressure value parameters of the specified command pattern data with the recorded planar coordinate data and/or the pressure value parameters stored in a memory or database 52. The command input device 5 comprises an interface module 19 for generating control signals and/or data signals on the basis of the at least one command parameter.

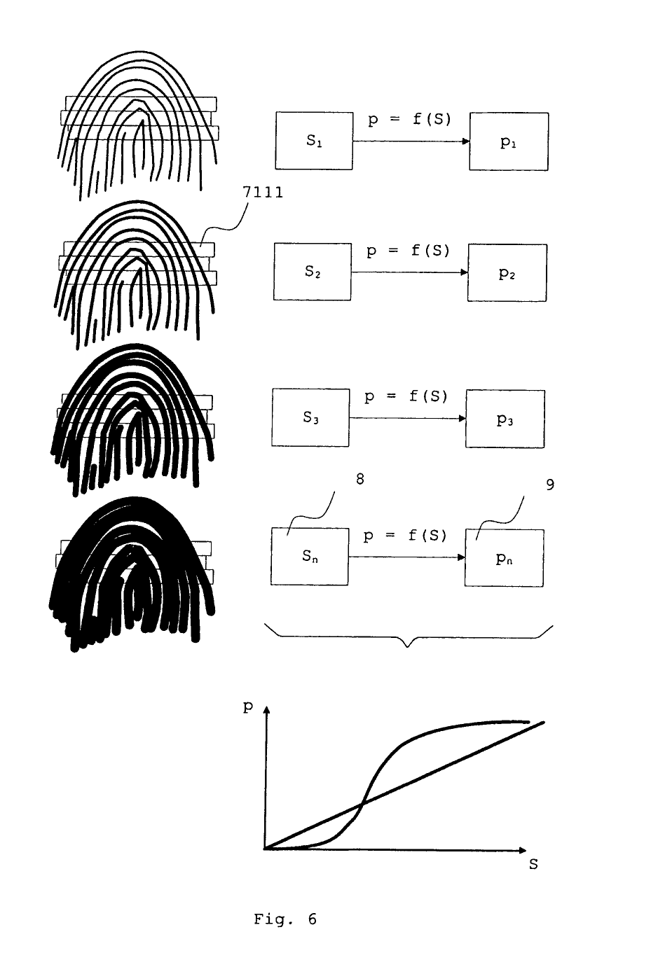

In FIG. 6, the reference 7111 denotes subregions of a subsurface 711 of an object 7. A subsurface 7111 may comprise a plurality of subregions 7111. Subregions 7111 may mutually overlap. The reference 9 shows a pressure indicator as a function of a reference value 8 or a stack memory level value. This dependency may be linear or nonlinear and, for example, described in a function. The pressure indicator or pressure value may also be in correlation with a reference value.

In FIGS. 7a and 7b, the references 1111 to 1119 denote pixels of a subsurface 711 of an object 7. The pixels can be recorded and stored as image data by using the image acquisition module 11 of the pressure measurement device 1. The color and/or brightness values of the pixels correspond to the distance of the elastically structured object surface, which touches the contact area 111 of the image acquisition module 11. The darker a pixel is, the more tightly the object surface lies on the contact area 111.

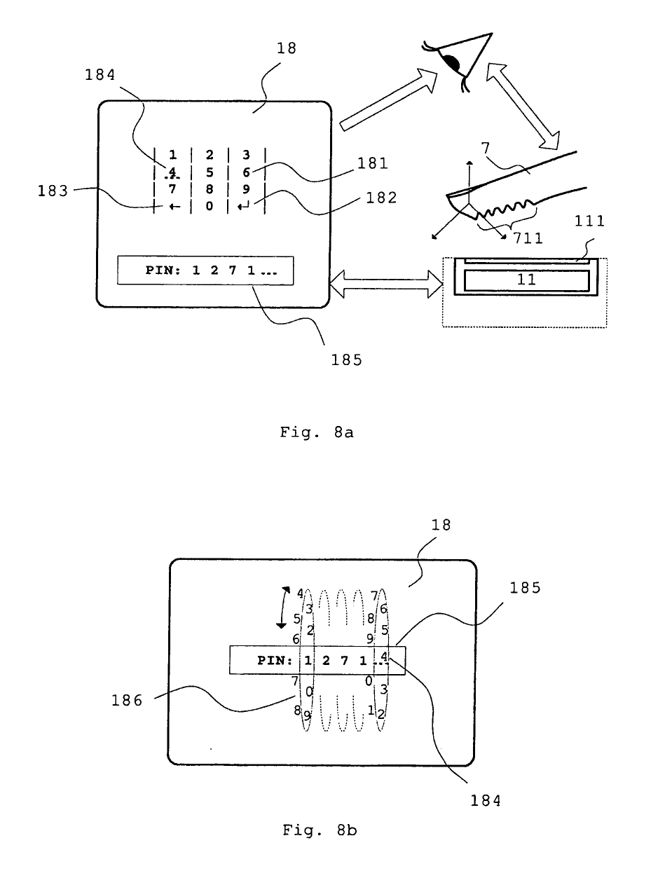

In FIG. 8a, the reference 18 denotes a display module, which is configured for example as a monitor or LCD display, symbols such as for example a personal identification number (PIN) being displayable. The pressure measurement device 1 may for example provide means used for the purpose of representing an input of a PIN denoted by the reference 185, the symbols available for selection being arranged as a virtual keypad or in a matrix. By using the pressure measurement device 1, the cursor element 14 can be controlled so that it is possible to select a particular symbol 181, a clear function 183 or an input confirmation function 182. A confirmation and/or “click” signal can be generated on the basis of the pressure value parameter determined by the pressure measurement device 1, in which case the chosen symbol is selected or accepted. The user reads the symbols represented on the display module 18 and moves the cursor element by using his or her finger 7 onto the symbol to be selected.

In FIG. 8b, the reference 18 denotes a display module. The reference 184 denotes the cursor element. The reference 185 refers to a personal identification number (PIN) or a symbol sequence. The reference 186 denotes an arrangement of symbols and/or numbers on a line, preferably on a line closed to form a circle. A symbol is chosen by moving an object 7 over the contact area 111. As a function of the x/y coordinate data determined by using the image acquisition module 11 of the pressure measurement device 1, the symbols on the line are moved past a cursor element. The desired symbol is selected by generating a pressure value parameter by using the pressure measurement device 1, and generating a selection signal when a particular limit value is reached. By using the pressure value parameter generated by the pressure measurement device 1, it is also possible to select a corresponding symbol from a multiplicity of symbols. This is done for example by the symbols arranged on a vertical line being moved past the cursor element 184 on the basis of the level of the pressure value parameter. The desired symbol is then selected on the basis of the x/y coordinate data, recorded by using the pressure measurement device, of an object 7 moved over the contact area 111 in order to execute a characteristic selection movement. Another possibility for the symbol input is achieved for example by selecting the higher-value numbers with greater pressure and a special symbol (clear, enter). The lower-value numbers are selected with a smaller pressure. The symbol is in this case selected by briefly removing the finger from the contact area 111.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A pressure measurement device for measuring a force exerted by a subsurface of an object onto a contact area of the pressure measurement device and for generating a corresponding pressure value parameter, the pressure measurement device comprising:
an image acquisition module having the contact area, for recording image data of an elastically structured subsurface of the object, pixels of the subsurface being recordable as at least one of graduated color values or brightness values of the image data according to their distance from the contact area;
an integration module having a stack memory which can be incremented according to the at least one of color values or brightness values of the image data, the stack memory having a readable stack memory level value; and
a filter module for generating the pressure value parameters, the pressure value parameters allocated by the filter module to the stack memory level value.

2. The pressure measurement device according to claim 1, wherein the filter module comprises:
a lookup table for storing value pairs which respectively comprise a reference value and a correspondingly allocated pressure value parameter; and
a comparison module for comparing a stack memory level value transmitted to the comparison module with the reference values of the lookup table, the corresponding pressure value parameter being allocatable on a basis of the comparison in order to generate the pressure value parameter by using the lookup table.

3. The pressure measurement device according to claim 1, wherein the filter module further comprises:
a correlation module for allocating a stack memory level value to a pressure value on the basis of at least one of an exponentiation factor, a multiplication factor, or an addition factor, the stack memory level value transmitted to the correlation module, the corresponding pressure value parameter being generatable on a basis of the correlation.

4. The pressure measurement device according to claim 1, further comprising:
an interface module for generating at least one of control signals or data signals on a basis of the pressure value parameter.

5. The pressure measurement device (according to claim 1, wherein the image acquisition module further comprises:
a scan module having at least one of an optically transparent, capacitive, or RF-sensitive contact area, pixels of the subsurface being recordable as at least on of a graduated color or brightness values of the image data according to their distance from the contact area.

6. A coordinate acquisition device comprising:
a touch-sensitive contact area for recording planar coordinate data of a subsurface of an object when touching the contact area; and
a coordinate acquisition module for generating corresponding signal data, wherein
the subsurface is elastically structured and the contact area is embodied as a component of a pressure measurement device according to claim 1, a corresponding pressure value parameter being generatable by using the pressure measurement device when the subsurface touches the contact area,
wherein the filter module generates z coordinate data as a function of the pressure value parameter, corresponding z coordinate data being allocatable to each possible pressure value parameter, and
wherein the coordinate acquisition module generates corresponding signal data as three-dimensional coordinate data on a basis of the z coordinate data and the planar coordinate data recorded by using the image acquisition module.

7. The coordinate acquisition device according to claim 6, wherein the coordinate acquisition device further comprises an interface module for generating at least one of control signals or data signals on the basis of the 3D coordinate data.

8. The coordinate acquisition device according to claim 6, wherein the filter module of the coordinate acquisition device comprises:
a lookup table, value pairs which respectively comprise a reference value and a correspondingly allocated pressure value parameter being storable in the lookup table, and wherein
the filter module comprises a comparison module for comparing a stack memory level value transmitted to the comparison module with the reference values of the lookup table, the corresponding z coordinate data being allocatable on a basis of the comparison in order to generate the z coordinate data by using the lookup table.

9. The coordinate acquisition device according to claim 6, wherein
the filter module of the coordinate acquisition device includes a correlation module for allocating a stack memory level value to the z coordinate data on a basis of at least one of an exponentiation factor, a multiplication factor, or an addition factor, the corresponding z coordinate data being generatable on a basis of the allocation, the stack memory value transmitted to the correlation module.

10. A navigation input device comprising:
a touch-sensitive contact area for recording planar x/y coordinate data of a subsurface of an object touching the contact area; and
a coordinate acquisition module and a timer module for generating corresponding time-dependent signal data, wherein
the pressure measurement device according to claim 1 comprises at least one of a timer or a scheduler module for generating at least one of a timebase or corresponding time value parameters, wherein
a planar x/y coordinate data can be recorded by using the image acquisition module of the pressure measurement device, and wherein
the navigation input device comprises an adder module for adding 3D coordinate data and time value parameters and for generating corresponding time-dependent 3D coordinate data.

11. The navigation input device according to claim 10, wherein the navigation input device further comprises:
an interface module for generating at least one of control signals or data signals on a basis of the time-dependent 3D coordinate data.

12. An authentication device for authenticating a user, identified stored image data of a fingerprint being comparable with image data to identify the image data of a further fingerprint, a corresponding authentication parameter being generatable as a function of the comparison, wherein
the pressure value parameter is recorded by using a pressure measurement device according to claim 1 that can be allocated to the image data of the first image to be identified, wherein
the pressure value parameter recorded by using a pressure measurement device according to claim 1 can be allocated to the image data of the further image, and wherein
the authentication device further comprises a filter module for generating the authentication parameter on a basis of the match of the corresponding pressure value parameters and as a function of the match of the identified image data with the image data of the further image.

13. An authentication device for authenticating a user, comprising:
means for identifying time-dependent x/y coordinate data of an elastically structured subsurface of an object that touches a touch-sensitive contact area, which are stored as signature data, being comparable with x/y coordinate data to be identified; and
means for generating corresponding authentication parameters, wherein
the contact area is a component of a navigation input device according to claim 10, corresponding time-dependent 3D coordinate data being generatable by using the navigation input device when the elastically structured subsurface of the object touches the contact area,
wherein the authentication device comprises means for storing time-dependent 3D coordinate data as signature data; and wherein
the authentication device comprises a filter module for generating the authentication parameter on a basis of the comparison of the signature data with the recorded 3D coordinate data.

14. The authentication device according to claim 12, wherein
the filter module of the authentication device comprises a lookup table, value pairs which respectively comprise a reference value and a correspondingly allocated pressure value parameter being stored in the lookup table, and in that the filter module comprises a comparison module for comparing a stack memory level value transmitted to the comparison module with the reference values of the lookup table, the corresponding authentication parameter being allocatable on a basis of the comparison in order to generate the authentication parameter by using the lookup table.

15. The authentication device according to claim 12, wherein
the authentication device further comprises an interface module for generating at least one of control signals or data signals on a basis of the at least one authentication parameter.

16. The authentication device according to claim 12, characterised
wherein the authentication device comprises means for determining subregions of subsurfaces of an object,
in that the authentication device comprises means for comparing at least two subregions for a match.

17. A command input device comprising
means for comparing planar coordinate data stored as specified command pattern data for a match with x/y coordinate data of a subsurface of an object that touches a touch-sensitive contact area; and
means for generating corresponding command parameters, wherein the contact area is a component of a pressure measurement device according to claim 1, wherein
the planar coordinate data recordable by using an image acquisition module of the pressure measurement device, wherein
corresponding pressure value parameters can be recorded by using the pressure measurement device, wherein
the command input device comprises a filter module for allocating corresponding pressure value parameters to a multiplicity of the planar coordinate data, wherein
the command input device comprises a filter module for generating the command parameter on a basis of the comparison of at least one of the planar coordinate data or the pressure value parameters of the specified command pattern data with at least one of the recorded planar coordinate data or the pressure value parameters, and wherein
the command input device comprises an interface module for generating at least one of control signals or data signals on a basis of the at least one command parameter.

18. A pressure measurement method, a force being exerted by an elastically structured subsurface of an object onto a contact area of a pressure measurement device, and corresponding pressure value parameters being generated, the method comprising the steps of:
recording image data of the subsurface of the object as at least one of graduated color or brightness values by using an image acquisition module of the pressure measurement device, the at least one of the graduated color or the brightness values generated according to their distance from the contact area;
incrementing an allocated stack memory on a basis of the at least one of the color or the brightness values of the image data by using an integration module of the pressure measurement device, a corresponding pressure value parameter being generated by using a filter module on a basis of the stack memory level value; and
generating at least one of a control signal or a data signal, and outputting the at least one of the control signal or the data signal on a basis of the pressure value parameter by using an interface module of the pressure measurement device.

19. The pressure measurement method according to claim 18, further comprising the steps of:
recording the force exertable by using the elastically structured subsurface onto the contact area of the pressure measurement device by using a calibrated second measurement pressure measurement device;
recording image data of the elastically structured subsurface of the object as at least one of graduated color or brightness values according to their distance from the contact area by using an image acquisition module of the pressure measurement device;
incrementing the allocated stack memory of an integration module of the pressure measurement device on a basis of the at least one of the color and the brightness values of the image data, a corresponding pressure value parameter being generated by using a filter module on a basis of the stack memory level value; and
transmitting the stack memory level value and the pressure value parameter allocated to the stack memory level value as a value pair into the lookup table or transmitting the stack memory level value and the pressure value parameter allocated to the stack memory level value as a calibration value pair into the correlation module of the pressure measurement device.

20. The method for the dynamic recording of multidimensional coordinate data on a basis of the spatial movement of an object, where a subsurface of the object is moved over a touch-sensitive contact area of a coordinate acquisition device, and planar x/y touch coordinate data is recorded and corresponding signal data being generated by using a coordinate acquisition module, the method comprising the steps of:
generating a corresponding pressure value parameter by using the pressure measurement device when the subsurface touches the contact area, the contact area being a component of a pressure measurement device;
generating corresponding z coordinate values by using a filter module of the coordinate acquisition device as a function of the pressure value parameter; and
generating three-dimensional coordinate data on a basis of the x/y coordinate data and the z coordinate data.

21. The navigation input method according to claim 20, further comprising the step of:
generating time value parameters by using at least one of a timer or scheduler module, time-dependent signal data being generated on a basis of the time value parameters and the three-dimensional coordinate data.

22. A biometric authentication method using a fingerprint sensor embodied as a contact area of a pressure measurement device that has an image acquisition module, the method comprising the steps of:
acquiring image data of a subregion of a first fingerprint by using the fingerprint sensor and recording the image data;
acquiring image data of a subregion of a second fingerprint being recorded by using the fingerprint sensor and storing the image data in association with a user-specific identification;
comparing the image data of the subregion of the first fingerprint with the image data of the subregion of the second fingerprint;
generating an authentication signal according to said step of comparing, wherein
a corresponding stack memory level value are generated by using a pressure measurement device on a basis of at least one of the graduated color or brightness values of the image data, wherein
the authentication signal is generated by using a filter module on a basis of the stack memory level values.

23. A signature authentication method, a user-specific signature being recorded and identified as reference coordinate data, a user-specific signature being recorded by using planar coordinate data for the authentication, and the recorded coordinate data being compared with stored and identified reference coordinate data and authentication parameters being generated according to the match, characterised
recording user-specific pressure value parameters by using a contact area of a pressure measurement device;
allocating a pressure value parameter to a multiplicity of the planar coordinate data by using the pressure measurement device;
correlating the user-specific profile of the pressure value parameters of the coordinate data with the profile of the pressure value parameters of the reference coordinate data when comparing the recorded coordinate data with the reference coordinate data; and
generating corresponding authentication parameters in a case where said step of correlating finds a match.

24. The signature authentication method according to claim 23, further comprising the steps of:
allocating image data of at least one of a fingerprint or a subsurface of an object to a multiplicity of the recorded coordinate data; and
comparing the recorded image data with the identified reference image data; and
generating corresponding authentication parameters being generated in a case where said step of comparing finds a match.

25. A command input method by using command input parameters based on command patterns storable as data in a memory module, the command pattern data being time-dependent x/y coordinate data, and for the generation of corresponding command input parameters, wherein
a command input parameter is generated on a basis of the time-dependent 3D coordinate data recorded by using a navigation input device according to claim 10, and the coordinate data stored as command patterns by using the filter module.

26. A text input method, at least one symbol being selectable from a multiplicity of symbols representable on a display module by using interaction with an object and an input unit, a cursor element being positioned on the display module by the interaction, the symbol being selected and a data signal being generated and transmitted on a basis of the position of the cursor element, the input unit is embodied as a contact area of a pressure measurement device having an image acquisition module according to claim 1, the method comprising the steps of:
recording planar coordinate data by using the pressure measurement device;
recording corresponding pressure value parameters by using the pressure measurement device, the cursor element being positioned as a function of the x/y coordinate data on the symbol to be selected;
selecting the chosen symbol on a basis of the pressure value parameter generated by using the pressure measurement device; and
generating the data signal and transmitting the data signal by using a filter module of the pressure measurement device on a basis of the selected symbol.

27. A text input method, at least one symbol being selectable from a multiplicity of symbols representable on a display module by using interaction with an object and an input unit, a cursor element being positioned on the display module by the interaction, the symbol being selected and a data signal being generated and transmitted on a basis of the position of the cursor element, the input unit includes a contact area of a pressure measurement device having an image acquisition module according to claim 1, planar coordinate data being recorded by using the pressure measurement device, the method comprising the steps of
recording corresponding pressure value parameters by using the pressure measurement device, the cursor element being positioned as a function of the pressure value parameter on the symbol to be selected,
selecting the symbol on a basis of the x/y coordinate data generated by using the pressure measurement device; and
generating the data signal and transmitted the data signal by using a filter module of the pressure measurement device on a basis of the selected symbol.
